(19) United States
(12) Patent Application Publication
(10) Pub. No.: US 2024/0169015 A1
(43) Pub. Date: May 23, 2024

(54) Machine Learning Methods for Deconvolution of Integral Transformations and Their Application to Experimental Data Analysis

(71) Applicant: UNM Rainforest Innovations, Albuquerque, NM (US)

(72) Inventors: Dimiter N. Petsev, Albuquerque, NM (US); Boian Alexandrov, Albuquerque, NM (US); Kim Orskov Rasmussen, Albuquerque, NM (US); Raviteja Vangara, Albuquerque, NM (US); Phan Minh Duc Truong, Albuquerque, NM (US)

(73) Assignee: UNM Rainforest Innovations, Albuquerque, NM (US)

(21) Appl. No.: 18/508,168

(22) Filed: Nov. 13, 2023

Related U.S. Application Data
(60) Provisional application No. 63/424,835, filed on Nov. 11, 2022.

(51) Int. Cl. G06F 17/11; G06F 17/14; G06F 18/23

(52) U.S. Cl. CPC G06F 17/11; G06F 17/14; G06F 18/23

(57) ABSTRACT

A system that expands a hybrid inverse method (hNMF) to integral equations and applications comprising: a laser source, a first lens that focusses light from said laser source on a sample with unscattered light creating a reference light line and with scattered light focused by a plurality lenses to a plurality of detectors at several scattering angles θᵢ, measured with respect to said reference light line, and for each said angle, θᵢ, a processor records the autocorrelation function g₁(t, θᵢ) over a period of time, T.

### RELATED APPLICATIONS

This application claims priority to U.S. Provisional Application No. 63/424,835, filed on 2022 Nov. 11, which is incorporated herein in its entirety.

### STATEMENT REGARDING FEDERALLY SPONSORED RESEARCH & DEVELOPMENT

This invention was made with government support by the Triad National Security, LLC (operating Los Alamos National Laboratory (LANL) grant DE-AC52-06NA25396. The government has certain rights in the invention.

### INCORPORATION BY REFERENCE OF MATERIAL SUBMITTED ON A COMPACT DISC

Not applicable.

### BACKGROUND OF THE INVENTION

Many important experiments provide data output in the form of an integral, while the important information remains hidden in the integrand or part of it. Examples for such experiments include Dynamic Light Scattering, Time-Resolved Fluorescence Spectroscopy, Mass Spectrometry, Positron annihilation, nuclear magnetic resonance (NMR), membrane pore size analysis, and others.

### SUMMARY OF THE INVENTION

In one embodiment, the present invention concerns focuses on the Dynamic Light Scattering (DLS) method, which is also known as photon correlation spectroscopy, used for determining particle and macromolecular size distributions in solutions. The DLS method is based on measuring the intensity of the photon auto-correlation function when the light is scattered by a suspension of particles, droplets, polymers, etc. The experimental output has the form (the diffusive components),

$${g}_{1} ( t ) = \int A ( D ) {e}^{- {q}^{2} Dt} dD \qquad ( 1 )$$

where g₁(t) is the experimentally obtained, time-dependent auto-correlation function,

$$q = 4 \frac{π {n}_{0}}{λ} sin ( θ / 2 ) ,$$

is the scattering angle-dependent wave-vector, D is the diffusion coefficient of the suspended species, e^{-q}^{²}^{Dt} is the autocorrelation function for perfectly monodisperse particles with identical diffusivities, and A(D) is the diffusion coefficient distribution function. The diffusion coefficient and each solute species is related to its hydrodynamic radius using the Stokes-Einstein relationship

$$D = \frac{{k}_{B} T}{6 πη R} \qquad ( 2 )$$

where k_{B}T is the thermal energy of the system, η is the shear viscosity of the solvent and R is the particle radius. Function A(D) is the particle size distribution function that usually contains important information for a range of industrial or research applications.

Eq. (1) is an integral transformation. More specifically, the experimentally obtained autocorrelation function g₁(t) is the Laplace transform of the size distribution function A(D). Hence, to extract the useful information in A(D), the Laplace transform is numerically inverted. This is not a trivial task. Laplace transform (unlike the Fourier transform) is very susceptible to noise, which means that the numerically obtained results could be unreliable.

Particularly difficult cases to resolve are those that involve broad, or multimodal size distributions. The current state-of-the-art and most popular method for inverting equations like (1) is based on a numerical method proposed by Provencher. This method is based on a constrained regularization and has been the tool of choice since its implementation more than 20 years ago. It works more or less well for multimodal distributions where the individual peaks are well separated but has limitations when this is not the case.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 shows a typical DLS configuration.

FIG. 2 provides examples demonstrating the results of the present invention when applied to synthetic data with a predetermined number of Gaussian particle distributions, namely with: 1 distribution, Panel A; 3 distributions, Panel B, and 4 distributions, Panel C. On the first row of FIG. 2, panels A, B and C demonstrate the determination of the number of distributions from the average Silhouette statistics (red) and Reconstruction error (blue), where the double array show the number of the distributions. On the second row of FIG. 2, panels A, B and C demonstrate the reproduction of the predetermined particle distributions for 1, 3, and 4 distributions, respectively.

FIG. 3 shows two Gaussian sources with different amplitudes in 4 different datasets.

FIG. 4 shows the mean Silhouettes and Relative error needed to find the number of sources shown in FIG. 3.

FIG. 5 shows four synthetic signal datasets from three angles=[30, 90, 250].

FIG. 6 shows the fit for the data set shown in FIG. 5.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention

### Rationale

A hybrid inverse method, called hNMF is based on unsupervised machine learning and inverse methodologies to investigate diffusion processes. hNMF integrates (a) the Green function reflecting the physics of the diffusion process and (b) an unsupervised learning method based on Non-negative Matrix Factorization (NMF) combined with a custom clustering algorithm.

The present invention provides a new method for inverting integral equations, such as Eq. (1), by expanding the ideas of hNMF to the realm of integral equations and applications including Dynamic Light Scattering, Time-Resolved Fluorescence Spectroscopy, Mass Spectrometry, Positron annihilation, nuclear magnetic resonance (NMR), membrane pore size analysis, and others.

### Physics of DLS:

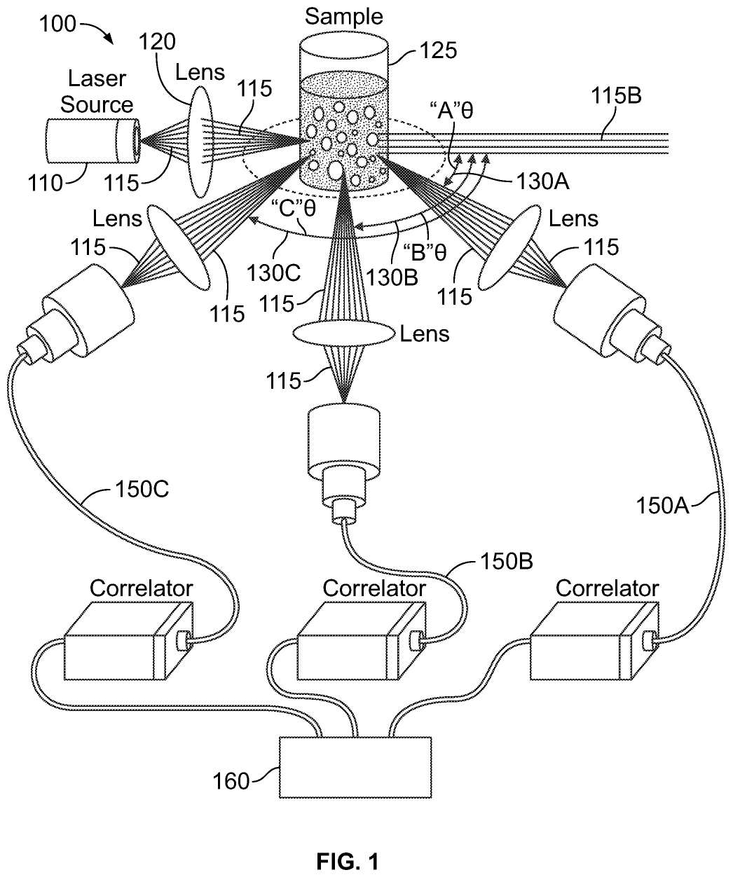

For one embodiment of the present invention, it is assumed that the DLS measurements shown above in FIG. 1 are taken at several scattering angles, and for each angle, θᵢ, the autocorrelation function g₁(t, θᵢ) is recorded over a period of time, T. DLS system 100 includes laser source which produces laser light 115 which is directed through lens 120 which focusses light 115 on sample 125. Part of light 115 that is not scattered by the sample, passes through sample 125 in a straight-line creating reference light-line 115B.

Light 115 is also scattered by the sample and is measured at various reference angles 130A-130C. Lenses 140A-C focus light into detectors 150A-C which provides the angular information to processor 160 which performs the processing functions set forth below.

If in the measured sample there are several distributions of particles, with different average size and dispersion, this reflects on the form of the distribution function A(D) and g₁(t, θᵢ). In the case, when in the sample we have K normally distributed sets of particles, we have,

$$A ( D ) = {\sum }_{i = 1}^{K} \frac{1}{{q}^{2} {σ}_{{D}_{i}} \sqrt{2 π}} exp ( - \frac{{( {x}_{i} - {μ}_{{D}_{i}} {q}^{2} )}^{2}}{2 {{σ}_{{D}_{i}}}^{2} {q}^{4}} ) ,$$

and therefore,

$${g}_{1} ( t ) = {\sum }_{i = 1}^{K} \frac{1}{{q}^{2} {σ}_{{D}_{i}} \sqrt{2 π}} {{\int }^{∞}}_{0} dx exp ( - \frac{{( {x}_{i} - {μ}_{{D}_{i}} {q}^{2} )}^{2}}{2 {{σ}_{{D}_{i}}}^{2} {q}^{4}} ) exp ( - {tx}_{i} ) ,$$

where, μ_{D}_{ᵢ}, σ_{D}_{ᵢ} are the expectation value and standard deviation of the i^{th} set of particles, while nᵢ and xᵢ=q²Dᵢ, are the concentration and corresponding integration variable. The above infinite integral is convergent and can be solved exactly,

$${g}_{1} ( t ) = {\sum }_{i = 1}^{K} ( \frac{{n}_{i}}{2} ) {e}^{- \frac{{{μ}_{{D}_{i}}}^{2}}{2 {{σ}_{{D}_{i}}}^{2}}} {e}^{{( \frac{- \frac{{μ}_{{D}_{i}}}{{σ}_{{D}_{i}}} + {q}^{2} {σ}_{{D}_{i}} t}{\sqrt{2}} )}^{2}} erfc ( \frac{- \frac{{μ}_{{D}_{i}}}{{σ}_{{D}_{i}}} + {q}^{2} {σ}_{{D}_{i}} t}{\sqrt{2}} ) ≡ {\sum }_{i = 1}^{K} {g}_{i} ( t , {θ}_{s} , {n}_{i} , {μ}_{{D}_{i}} , {σ}_{{D}_{i}} )$$

where,

$${g}_{i} ( t , {θ}_{s} , {n}_{i} , {μ}_{{D}_{i}} , {σ}_{{D}_{i}} ) = ( \frac{{n}_{i}}{2} ) {e}^{- \frac{{{μ}_{{D}_{i}}}^{2}}{2 {{σ}_{{D}_{i}}}^{2}}} {e}^{{( \frac{- \frac{{μ}_{{D}_{i}}}{{σ}_{{D}_{i}}} + {{q}_{s}}^{2} {σ}_{{D}_{i}} t}{\sqrt{2}} )}^{2}} erfc ( \frac{- \frac{{μ}_{{D}_{i}}}{{σ}_{{D}_{i}}} + {{q}_{s}}^{2} {σ}_{{D}_{i}} t}{\sqrt{2}} )$$

### Deconvolution:

To extract the distribution characteristics and identify the number of normal modes, a version of hNMF, developed for DLS is applied. Specifically, gᵢ(t, θₛ, nᵢ, μ_{D}_{ᵢ}, σ_{D}_{ᵢ}) is treated mathematically as a pseudo-Green function. In this case, the time-dependent autocorrelation function g₁(t) is represented as a sum of transient signals, each recorded by s detectors 150A-C (each “detector” corresponds to a record at the angle θₛ 130A-130C), generated from a probability distribution with mean,

$$〈 {g}_{{θ}_{s} ; {t}_{m}} 〉 = {\sum }_{i = 1}^{K} {W}_{( {θ}_{s} ; {t}_{m} ) i} {H}_{i}$$

where,

$${W}_{( {θ}_{s} ; {t}_{m} ) i} = {e}^{{( \frac{- \frac{{μ}_{{D}_{i}}}{{σ}_{{D}_{i}}} + {{q}_{s}}^{2} {σ}_{{D}_{i}} t}{\sqrt{2}} )}^{2}} erfc ( \frac{- \frac{{μ}_{{D}_{i}}}{{σ}_{{D}_{i}}} + {{q}_{s}}^{2} {σ}_{{D}_{i}} t}{\sqrt{2}} )$$

$$and ,$$

$${H}_{i} = ( \frac{{n}_{i}}{2} ) {e}^{- \frac{{{μ}_{{D}_{i}}}^{2}}{2 {{σ}_{{D}_{i}}}^{2}}}$$

The index s denotes the angle θₛ of the recording and the index tₘ denotes the time point when the observation was recorded. The kernels W_{(θ}_{ₛ}_{;t}_{ₘ}₎ᵢ are the pseudo-Green functions in DLS that depend on angle and time, and H contains K hidden variables, independent of time and angle, that generate the observables g_{θ}_{ₛ}_{;t}_{ₘ} at (θₛ;tₘ) via the weights W_{(θ}_{ₛ}_{;t}_{ₘ}₎ᵢ. Both W_{(θ}_{ₛ}_{;t}_{ₘ}₎ᵢ and Hᵢ are non-negative. For given angles, time points, and the functional form of gᵢ(t, θₛ), the present invention can utilize hNMF to estimate the (unknown) number of modes, K, and to determine the parameters nᵢ, μ_{D}_{ᵢ}, σ_{D}_{ᵢ}. In this interpretation, the hNMF minimization is performed by nonlinear least squares to minimize the following objective function,

$$O = {\sum }_{s = 1}^{N} {\sum }_{i = 1}^{T} {( {g}_{{θ}_{s} ; {t}_{m}} - {\sum }_{i = 1}^{K} ( \frac{{n}_{i}}{2} ) {e}^{- \frac{{{μ}_{{D}_{i}}}^{2}}{2 {{σ}_{{D}_{i}}}^{2}}} {e}^{{( \frac{- \frac{{μ}_{{D}_{i}}}{{σ}_{{D}_{i}}} + {{q}_{s}}^{2} {σ}_{{D}_{i}} t}{\sqrt{2}} )}^{2}} erfc ( \frac{- \frac{{μ}_{{D}_{i}}}{{σ}_{{D}_{i}}} + {{q}_{s}}^{2} {σ}_{{D}_{i}} t}{\sqrt{2}} ) )}^{2}$$

The present invention iteratively solves the above minimization for K=1, 2, 3, . . . , Kₘₐₓ. For each given number of modes K, the present invention performs approximately M=˜200 minimizations, each one with random initial conditions and resampling of g_{θ}_{ₛ}_{;t}_{ₘ}.

### Determination of the Number of Normal Modes:

The nonlinear least-squares is sufficient to carry a constrained optimization problem and to extract desired parameters if the number of modes K is known, which however is not the case here. To determine this unknown number of modes here, all possible number of modes are explored, K, starting from K=1, 2, . . . , P, where P is less than min(N, T). For each explored number of modes K, (called a run), a new observational data is generated by resampling and obtain a set of solutions U_{K}, that include M-pairs, [W^{p}_{(θ}_{ₛ}_{;t}_{ₘ}₎ᵢ, H^{p}ᵢ], p=1, 2, . . . M. Finally, on the set of these M˜200 solutions, obtained for each possible K, the present invention performs customized clustering, assigning the parameters of each of these solutions to one of K clusters. This customized clustering is similar to k-means clustering but with an additional constraint constraining the number of elements in each of the clusters to be equal to the number of solutions M. During the clustering, the similarity between the elements is measured by the Euclidean distance.

Further, to determine the optimum number of modes, the clusters' stability for each explored number of modes K are calculated. The number of modes K that estimates the true number is the number of modes for which the corresponding K clusters are stable and separable and whose centroids reconstruct the experimental data well (see Examples). To quantify the stability and separability of the clustering for a given number of modes, Silhouette statistics may be used to measure the similarity between the elements of a cluster compared to the centroids of the other clusters.

Another metric that may be used is the relative reconstruction error R=∥g−WH∥/∥g∥, which measures the relative deviation of the obtained solution W*H from the original data g_{θ}_{ₛ}_{;t}_{ₘ}. The reconstruction error R evaluates the accuracy with which our solution, that is, the solution constructed with the parameters taken from the centroids of the clusters, reproduce the observed data g_{θ}_{ₛ}_{;t}_{ₘ}.

Specifically, the present invention also calculates the average Silhouette width, S, and the average reconstruction error, R, for each choice of the unknown number of modes, to estimate the true number of modes, K. K is determined to be equal to the number of modes that accurately reconstruct the observations (i.e., their relative reconstruction error R is small enough) and the clustering of the sets of solutions corresponding to K, obtained with random initial conditions and resampling, to be sufficiently robust (S is close to 1).

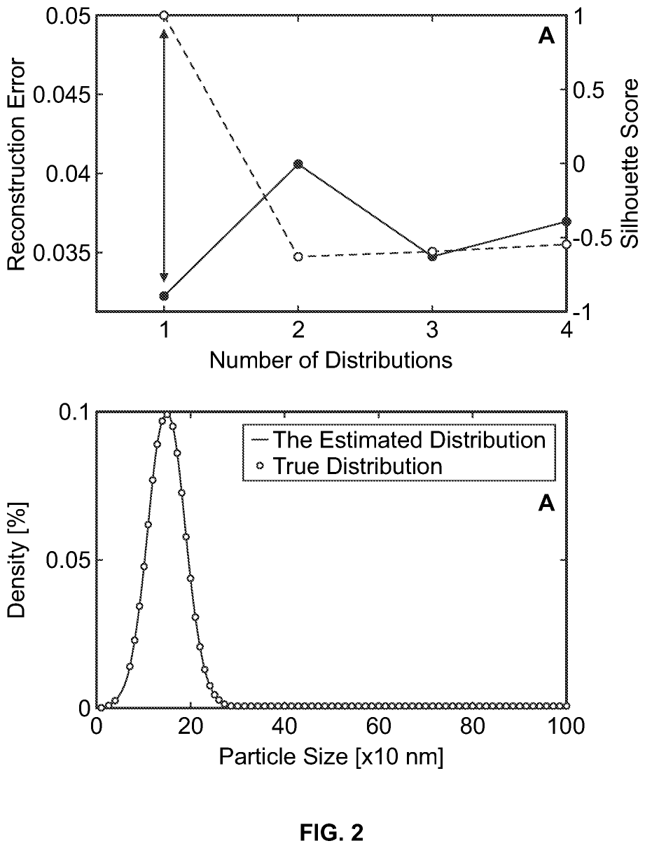

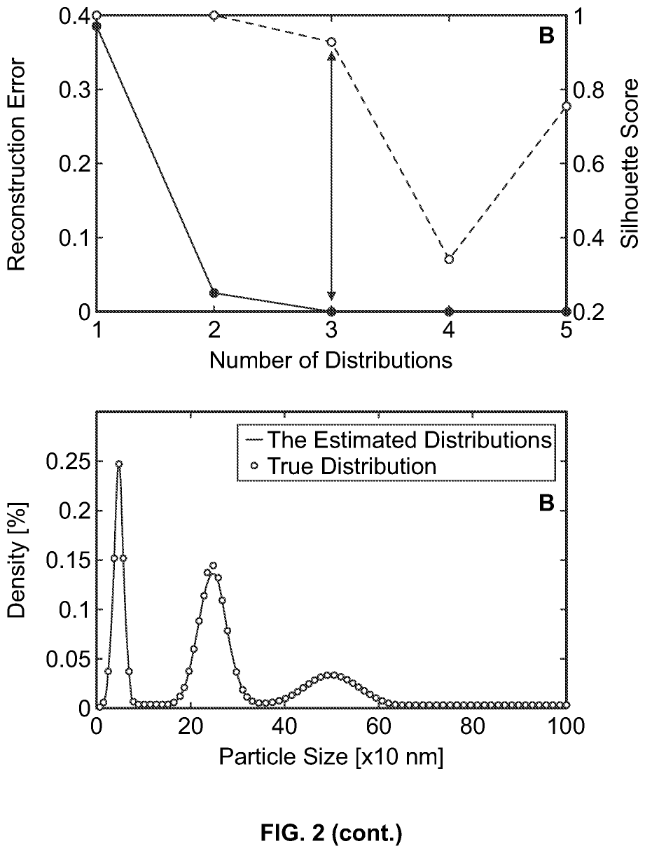

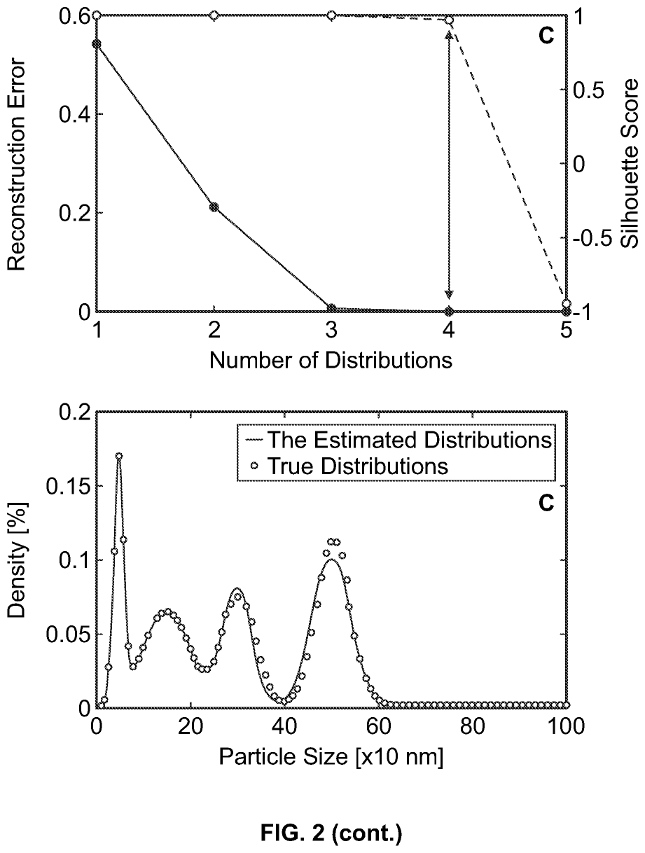

FIG. 2 provides examples demonstrating the results of the present invention when applied to synthetic data with a predetermined number of Gaussian particle distributions, namely with: 1 distribution, Panel A; 3 distributions, Panel B, and 4 distributions, Panel C. On the first row of FIG. 2, panels A, B and C demonstrate the determination of the number of distributions from the average Silhouette statistics (red) and Reconstruction error where the double array shows the number of the distributions. On the second row of FIG. 2, panels A, B and C demonstrate the reproduction of the predetermined particle distributions for 1, 3, and 4 distributions, respectively.

Other types of distributions can also be utilized with the same purpose. It should be emphasized that the present invention is not limited to normal particle size distributions. In fact, it can be applied to arbitrarily distributed systems (the integral in (1) can be solved numerically in this case). An arbitrary distribution can be expressed in terms of a sum of normally distributed source functions (as in the present example). Alternatively, a different set of functions, e.g., log-normal can be chosen.

Finally, the method applies to integrals with different kernels. For example, in fluorescent spectroscopy, where the autocorrelation function has the form,

$${g}_{{τ}_{D}} = \frac{1}{N} {( 1 + \frac{t}{{τ}_{D}} )}^{- 1} {( 1 + \frac{t}{{k}^{2} {τ}_{D}} )}^{- 1 / 2} ,$$

which relates to the distribution function for the diffusivities A(D) using an equation similar to (1), or

$${g}_{1} ( t ) = \frac{1}{N} \int A ( D ) {( 1 + \frac{t}{{τ}_{D}} )}^{- 1} {( 1 + \frac{t}{{k}^{2} {τ}_{D}} )}^{- 1 / 2} dD ,$$

where N is the number of species, k is an instrument parameter and τ_{D} is the diffusion time. Hence, g_{τ}_{_{D}} is analogous to e^{-q}^{²}^{Dt} in Eq. (1).

The data analysis method disclosed here, should be of interest to any company that manufactures Dynamic Light Scattering, Fluorescence spectroscopy, NMP, Mass Spectrometry, and Positron Annihilation spectroscopy instruments.

### Machine Learning Methods for Deconvolution of Integral Transformations and Their Application to Experimental Data Analysis Involving Concentration and Aliquot Variations

For other embodiments of the present invention, the proposed Machine Learning (ML) approach for data analysis is in the fact that a given sample requires a sufficient amount of data for better statistical analysis. In addition, these data are best collected at slightly different conditions. This is a unique feature of the unsupervised ML techniques. The idea is that the same object of analysis (e.g., particle size distribution) reveals different features at different conditions, which allows for an accurate recognition and reconstruction. In a Dynamic Light Scattering (DLS) experiment a natural parameter may be varied to obtain the necessary data, because it is often a built-in option in many instruments. However, some inexpensive, but very widespread DLS instruments allow for a limited number of angles. This limits the amount of data for the ML analysis and therefore cannot lead to an accurate enough statistical analysis and derivation of complex particle distributions.

The present invention extends the ML analysis method to include concentration and aliquot variations. This means a limited number limited and insufficient of scattering angles can be compensated by preparing a series of samples at different total concentrations, or different aliquots (the relative concentrations of different species). This extension of the method is extremely useful, because preparing multiple samples is trivial and it becomes very easy to generate as much data as needed without the need for more sophisticated equipment, or additional instruments.

This modified ML method of the present invention was able to derive a series of bimodal particle size distributions for a data sample.

In other embodiments of the present invention, the concentration variation can be used in combination with the angle variation.

In other embodiments of the present invention, the number of modes can be predetermined and can be greater than two. Thus, the present invention is not necessarily limited to bimodal distributions, but other applications include but at not limited to trimodal and higher distributions.

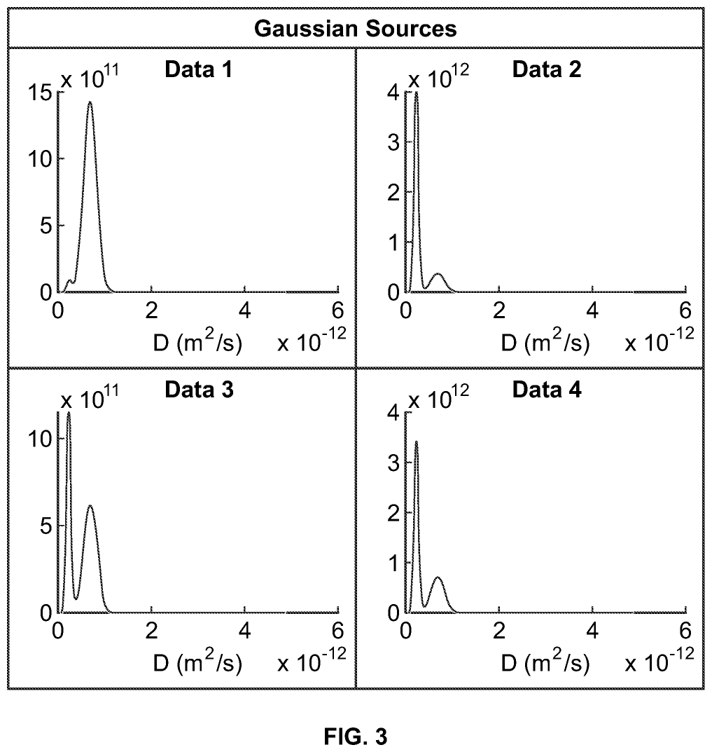

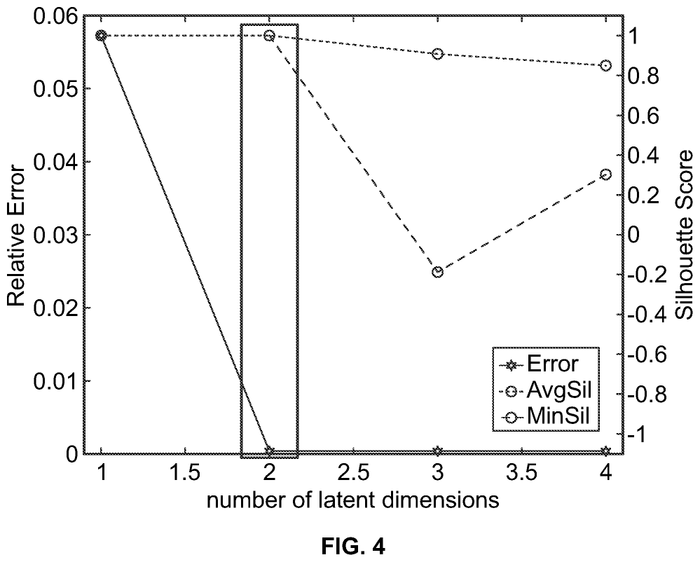

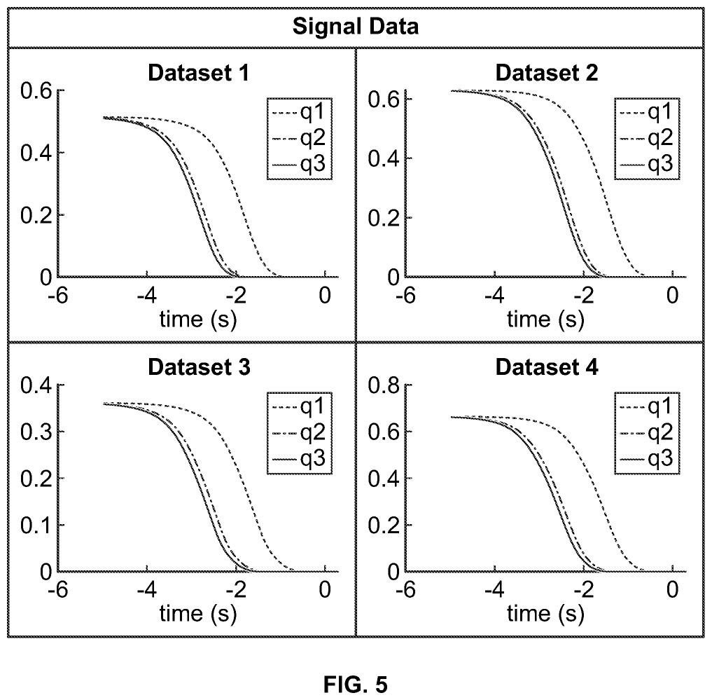

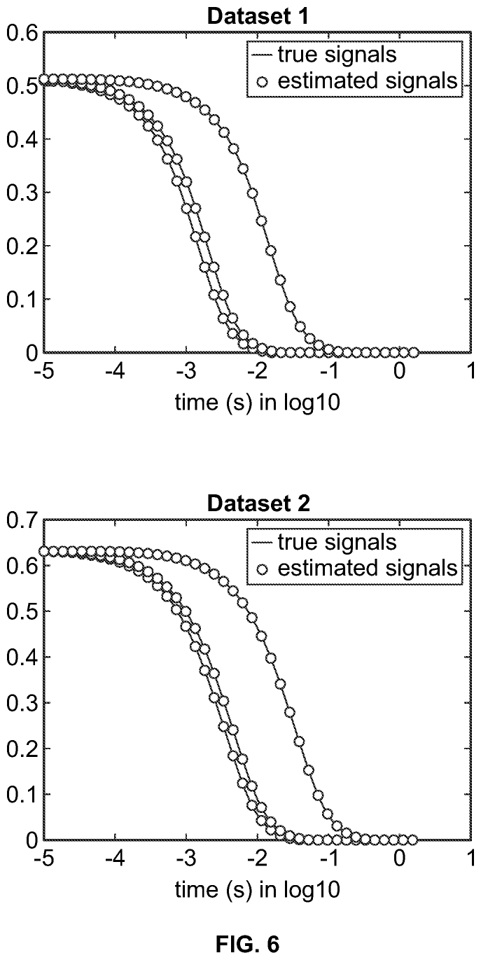

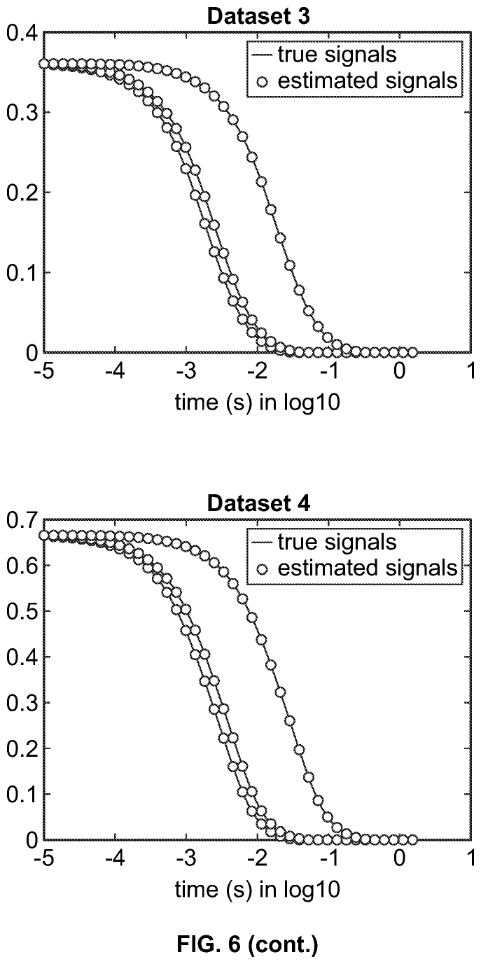

FIGS. 3-6 are synthetic data results from the embodiments of the present invention. Provided are two Gaussian sources: (mu1=1/1000, sigmal=0.2/1000), (mu2=1/350, sigma2=0.2/350). The four datasets are generated by mixing these two Gaussian sources with different amplitudes. Amplitude values for each dataset: Dataset 1: A1=0.0104, A2=0.5019; Dataset 2: A1=0.4958, A2=0.133; Dataset 3: A1=0.1421, A2=0.2186; Dataset 4: A1=0.4185, A2=0.2481. And for each set there are three angles: [30 90 250].

The results, that is, the extracted sources are pictured in FIGS. 3-6,

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A system that expands a hybrid inverse method (hNMF) to integral equations and applications comprising: a laser source, a first lens that focusses light from said laser source on a sample with unscattered light creating a reference light line and with scattered light focused by a plurality lenses to a plurality of detectors at several scattering angles θᵢ, measured with respect to said reference light line, and for each said angle, θᵢ, a processor records the autocorrelation function g₁(t, θᵢ) over a period of time, T.

2. The system of claim 1 wherein said processor integrates (a) the Green function reflecting the physics of the diffusion process and (b) includes an unsupervised learning system based on Non-negative Matrix Factorization (NMF) combined with a clustering algorithm.

3. The system of claim 3 wherein to extract distribution characteristics and identify the number of normal modes, gᵢ(t, θₛ, nᵢ, μ_{D}_{ᵢ}, σ_{D}_{ᵢ}) is treated mathematically as a pseudo-Green function.

4. The system of claim 4 wherein the time-dependent autocorrelation function g₁(t) is represented as a sum of transient signals, each recorded by said detectors, is generated from a probability distribution with mean.

5. The system of claim 1 the functional form of gᵢ(t, θₛ,), the number of modes, K, are estimated by said processor to determine the parameters nᵢ, μ_{D}_{ᵢ}, σ_{D}_{ᵢ}.

6. The system of claim 5 wherein the minimization for K=1, 2, 3, . . . , Kₘₐₓ is iteratively solved for each given number of modes K.

7. The system of claim 6 wherein approximately M=˜200 minimizations are performed, each one with random initial conditions and resampling of g_{θ}_{ₛ}_{;t}_{ₘ}.

8. The system of claim 7 wherein, to determine the number of unknown modes, all possible number of modes are explored, K, starting from K=1, 2, . . . , P, where P is less than min(N, T).

9. The system of claim 8 wherein, for each explored number of modes K, new observational data is generated by resampling and obtain a set of solutions U_{K}, that include M-pairs, [W^{p}_{(θ}_{ₛ}_{;t}_{ₘ}₎ᵢ, H^{p}ᵢ], p=1, 2, . . . M.

10. The system of claim 7 wherein, on the set of these M˜200 solutions, obtained for each possible K, customized clustering is performed by assigning the parameters of each of the solutions to one of K clusters.

11. The system of claim 10 wherein the [symbol] custers' stability for each explored number of modes K are calculated.
